(19) United States
(12) Patent Application Publication
(10) Pub. No.: US 2009/0305595 A1
(43) Pub. Date: Dec. 10, 2009

(54) ACOUSTIC FIBER SHEET AND SHAPED ARTICLE UTILIZING THE SAME

(76) Inventors: Masanori Ogawa, Aichi (JP); Tsuyoshi Watanabe, Aichi (JP); Makoto Fujii, Aichi (JP)

Correspondence Address: COOPER & DUNHAM, LLP, 30 Rockefeller Plaza, 20th Floor, NEW YORK, NY, 10112, US

(21) Appl. No.: 12/309,092

(22) PCT Filed: Jun. 18, 2007
(86) PCT No.: PCT/JP2007/062235

§ 371 Date: Jan. 5, 2009

(30) Foreign Application Priority Data
Jul. 6, 2006 (JP) 2006-186228

(51) Int. Cl. E04B 1/74; D04H 1/40; G10K 11/16

(52) U.S. Cl. 442/402; 252/62; 442/414; 181/175

(57) ABSTRACT

A sound absorbing fiber sheet, the ventilation resistance of which is in the range of between 0.08 and 3.00 kPa·s/m, is provided in the present invention, the sound absorbing fiber sheet being laminated onto a fiber base sheet to be a laminated fiber sheet having a good sound absorbing property even with the fiber base sheet having a small unit weight, and said laminated sheet may be molded into a desirable shape.

### FIELD OF THE INVENTION

The present invention relates to a sound absorbing fiber sheet, and said sound absorbing fiber sheet may be laminated onto a fiber base sheet, and used for such as a sound absorbing material of a car.

### BACKGROUND OF THE INVENTION

A fiber sheet or a fiber mat has been used as a sound absorbing material of the vehicles such as cars, and the walls, floors and ceilings of buildings and the like.

A surface material made of a nonwoven fabric is generally laminated onto said fiber sheet or fiber mat to impart a good design and even surface and to prevent shagging and loosening.

Said sound absorbing material must be light especially for automotive use. Nevertheless, in a case where the unit weight of the fiber sheet or fiber mat is reduced to be lighter, the sound absorbing property of the resulting fiber sheet or mat may deteriorate. Therefore, a structure where a foamed synthetic resin sheet is laminated onto said fiber sheet or mat has been proposed.
Patent Literature: JP 2003-19930
Patent Literature: JP 2003-81028

### DISCLOSURE OF THE INVENTION

### Problems to be Solved by the Invention

Said foamed synthetic resin sheet has a good sound absorbing property but poor rigidity, so that in a case where a laminated material in which said foamed synthetic resin sheet is laminated onto said fiber sheet or mat is molded, the resulting molded laminated material has poor dimensional stability and workability in handling.

### Means to Solve Said Problems

As means to solve said traditional problem, the present invention provides a sound absorbing fiber sheet comprising a fiber sheet the ventilation resistance of which is in the range of between 0.08 and 3.00 kPa·s/m. Said fiber sheet, wherein polyammonium phosphate and/or expandable graphite is (are) preferably contained.

Further, said fiber sheet, wherein fibers having a low melting point of below 180° C. are preferably mixed.

A nonwoven fabric in which fibers are bound by a synthetic resin binder or intertwined by needling is advantageously used as said fiber sheet.

It is preferable that said synthetic resin binder is a phenol group resin and that in this case said phenol group resin is preferably sulfomethylated and/or sulfimethylated.

The present invention also provides a molded fiber sheet comprising a molded laminated fiber sheet wherein said sound absorbing fiber sheet(s) is(are) laminated onto one or both sides of a fiber base sheet

In a case where said sound absorbing fiber sheet comprising a fiber sheet the ventilation resistance of which is in the range of between 0.08 and 3.00 kPa·s/m is laminated onto a fiber base material being a fiber sheet or fiber mat, the resulting laminated fiber sheet has a good sound absorbing property especially from middle frequency band to high frequency band even if the unit weight of said fiber base sheet is reduced.

In a case where polyammonium phosphate and/or expandable graphite is/are contained in said fiber sheet, a sound absorbing fiber sheet having an excellent flame retardancy is provided.

In a case where a fiber having a low melting point below 180° C. is mixed into said fiber sheet, the rigidity of said sound absorbing fiber sheet can be improved by heating said fiber sheet to soften said fiber having a low melting point and bind the fibers with said softened fiber having a low melting point.

In a case where said fiber sheet is a nonwoven fabric wherein fibers are bound by a synthetic resin binder or intertwined by needling, a sound absorbing fiber sheet having high rigidity is provided.

In a case where said synthetic resin binder is a phenol group resin, a sound absorbing fiber sheet having a much higher rigidity is provided, and in a case where said phenol group resin is sulfomethylated and/or sulfimethylated, the resulting phenol group resin provides a stable water solution in the wide pH range, so that many kinds of curing agent and additive can be added to the water solution of said sulfomethylated and/or sulfimethylated phenol group resin. A molded fiber sheet made by laminating said sound absorbing fiber sheet(s) onto one or both sides of a fiber base sheet, and then molding the resulting laminated sheet into a prescribed shape has a good sound absorbing property improved by said sound absorbing fiber sheet, so that the unit weight of the resulting molded laminated sheet can be reduced.

Accordingly in the present invention, a light sound absorbing material having a high rigidity, and a good sound absorbing property is provided.

### BRIEF DESCRIPTION OF THE DRAWING

FIG. 1: FIGURE to illustrate the principle to determine the ventilation resistance.

### PREFERRED EMBODIMENT

The present invention is illustrated precisely below.

### [Fiber]

The fiber used in the present invention is, for example, a synthetic resin such as polyester fiber, polyamide fiber, acrylic fiber, urethane fiber, polyvinyl chloride fiber, polyvinylidene chloride fiber, acetate fiber, or the like, natural fiber such as wool, mohair, cashmere, camel hair, alpaca, vicuna, angora, silk, cotton wool, cattail fiber, pulp, cotton, coconut fiber, kenaf fiber, hemp fiber, bamboo fiber, abaca fiber or the like, biodegradable fiber made from lactic acid produced from such as corn starch, or the like, cellulose group synthetic fiber such as rayon fiber, staple fiber, polynosic fiber, cupro-ammonium rayon fiber, acetate fiber, triacetate fiber, or the like, inorganic fiber such as glass fiber, carbon fiber, ceramic fiber, asbestos fiber, or the like, and reclaimed fiber obtained by the fiberizing of a fiber product made of said fibers. Said fiber is used singly, or two or more kinds of said fiber may be used in combination in the present invention.

Further, in the present invention, fiber having a low melting point of 180° C. or below is desirably used wholly or partially as said other fiber.

Said low melting point fibers include, for example, polyolefine group fiber such as polyethylene fiber, polypropylene fiber ethylene-vinyl acetate copolymer fiber, ethylene-ethyl acrylate copolymer fiber, or the like, polyvinyl chloride fiber, polyurethane fiber, polyester fiber, polyester copolymer fiber, polyamide fiber, polyamide copolymer fiber, or the like. Said fibers having a low melting point may be used singly, or two or more kinds of said fiber may be used in combination.

Further, a preferable fiber having a low melting point is a core-shell type composite fiber in which the core component is ordinary fiber, and the shell component is a synthetic resin having a low melting point which is the material of said fiber having a low melting point. Since said core component of said core-shell type composite fiber is ordinary fiber, the resulting fiber sheet has a high rigidity and good heat resistance. The fineness of said fiber having a low melting point is in the range of between 0.1 and 60 dtex. Generally said fiber having a low melting point is mixed into said fiber sheet in an amount of between 1 and 50% by mass.

### [Manufacturing the Fiber Sheet]

Said fiber sheet of the present invention is manufactured by such as the spun bonding method, wherein in a case where said fiber is a thermoplastic fiber, said thermoplastic resin as the material of said thermoplastic fiber is melted and extruded in threads and said melted thread shaped thermoplastic resin is intertwined and fused so as to be a fiber sheet, the needle punching method, wherein the web sheet or web mat is needle punched to intertwine fibers within said web sheet or web mat, the melting/bonding method, wherein in a case of the web sheet or web mat containing, low melting point fiber, said sheet or mat is heated to melt said low melting point fiber, the resulting melted fibers binding fibers to each other, the resin binding method, wherein a synthetic resin binder is impregnated or mixed into said sheet or mat to bind fibers with said synthetic resin binder, the needle punching/resin binding method, wherein a synthetic resin binder is impregnated into a needle punched web sheet or web mat to bind fibers together with said synthetic resin binder, and the knitting or weaving method, or the like.

Said synthetic resin used as a binder for said fiber sheet is, for example, a thermoplastic synthetic resin such as polyethylene, polypropylene, ethylene-propylene copolymer, ethylene-propylene terpolymer, ethylene-vinyl acetate copolymer, polyvinyl chloride, polyvinylidene chloride, polystyrene, polyvinyl acetate, fluorocarbon polymers, thermoplastic acrylic resin, thermoplastic polyester, thermoplastic polyamide, thermoplastic urethane resin, acrylonitrile-butadiene copolymer, styrene-butadiene copolymer, acrylonitrile-butadiene-styrene copolymer, or the like; a thermosetting resin such as urethane resin, melamine resin, heat hardening type acrylic acid resin, urea resin, phenolic resin, epoxy resin, heat hardening type polyester, or the like. Further, a synthetic resin precursor which produces said synthetic resin such as prepolymer, oligomer monomer, or the like may be used. Said prepolymer, oligomer, monomer, or the like, may include a urethane resin prepolymer, epoxy resin prepolymer, melamine resin prepolymer, urea resin prepolymer, phenol resin prepolymer, diallyl phthalate prepolymer, acrylic oligomer, polyisocyanate, methacryl ester monomer, diallyl phthalate monomer, or the like. Said synthetic resin binder may be used singly, or two or more kinds of said synthetic resin may be used together, and said synthetic resin binder may commonly be provided as a powder, emulsion, latex, water solution, organic solvent solution, or the like.

A desirable synthetic resin binder to be used in the present invention is a phenol group resin. Said phenol group resin to be used in the present invention is described below.

Said phenol group resin is produced by the condensation reaction between the phenol group compound and formaldehyde and/or a formaldehyde donor.

### (Phenol Group Compound)

The phenolic compound used to produce said phenolic resin may be a monohydric phenol, or polyhydric phenol, or a mixture of monohydric phenol and polyhydric phenol, but in a case where only a monohydric phenol is used, formaldehyde is apt to be emitted when or after said resin composition is cured, making polyphenol or a mixture of monophenol and polyphenol most desirable.

### (Monohydric Phenol)

The monohydric phenols include an alkyl phenol such as o-cresol, m-cresol, p-cresol, ethylphenol, isopropylphenol, xylenol, 3,5-xylenol, butylphenol, t-butylphenol, nonylphenol or the like; a monohydric derivative such as o-fluorophenol, m-fluorophenol, p-fluorophenol, o-chlorophenol, m-chlorophenol, p-chlorophenol, o-bromophenol, m-bromophenol, p-bromophenol, o-iodophenol, m-iodophenol, p-iodophenol, o-aminophenol, m-aminophenol, p-aminophenol, o-nitrophenol, m-nitrophenol, p-nitrophenol, 2,4-dinitrophenol, 2,4,6-trinitrophenol or the like; a monohydric phenol of a polycyclic aromatic compound such as naphthol or the like. Each monohydric phenol can be used singly, or as a mixture thereof.

### (Polyhydric Phenol)

The polyhydric phenols mentioned above, include resorsin, alkylresorsin, pyrogallol, catechol, alkyl catechol, hydroquinone, alkyl hydroquinone, phloroglucinol, bisphenol, dihydroxynaphthalene or the like. Each polyhydric phenol can be used singly, or as a mixture thereof. Resorsin and alkylresorsin are more suitable than other polyhydric phenols. Alkylresorsin, in particular is the most suitable of polyhydric phenols because alkylresorsin can react with aldehydes more rapidly than resorsin.

The alkylresorsins include 5-methyl resorsin, 5-ethyl resorsin, 5-propyl resorsin, 5-n-butyl resorsin, 4,5-dimethyl resorsin, 2,5-dimethyl resorsin, 4,5-diethyl resorsin, 2,5-diethyl resorsin, 4,5-dipropyl resorsin, 2,5-dipropyl resorsin, 4-methyl-5-ethyl resorsin, 2-methyl-5-ethyl resorsin, 2-methyl-5-propyl resorsin, 2,4,5-trimethyl resorsin, 2,4,5-triethyl resorsin, or the like.

A polyhydric phenol mixture produced by the dry distillation of oil shale, which is produced in Estonia is inexpensive, includes 5-methyl resorcin, along with many other kinds of alkylresorcin which is highly reactive, so that said polyhydric phenol mixture is an especially desirable raw polyphenol material in the present invention

### [Formaldehyde Donor]

In the present invention, said phenolic compound and aldehyde and/or aldehyde donor (aldehydes) are condensed together. Said aldehyde donor refers to a compound or a mixture which emits aldehyde when said compound or said mixture decomposes. Said aldehyde donor is such as paraformaldehyde, trioxane, hexamethylenetetramine, tetraoxymethylene, or the like.

In the present invention, a formaldehyde and formaldehyde donor are denominated together as a formaldehyde group compound.

### [Production of Phenol Group Resin]

Said phenol group resin has two types, one is a resol type, which is produced by the reaction of said phenol group compound to an excess amount of said formaldehyde group compound using an alkali as a catalyst, and the other novolak type is produced by the reaction of an excess amount of said phenol group compound to said formaldehyde group compound using an acid as a catalyst. Said resol type phenol group resin consists of various phenol alcohols produced by the addition of formaldehyde to phenol, and is commonly provided as a water solution, while said novolak phenol group resin consists of various dihydroxydiphenylmethane group derivatives, wherein the phenol group compounds are further condensed with phenol alcohols, said novolak type phenol group resin being commonly provided as a powder.

In the use of said phenol group resin in the present invention, said phenol group compound is first condensed with a formaldehyde group compound to produce a precondensate, after which the resulting precondensate is applied to said fiber sheet, which is followed by resinification with a curing agent, and/or heating.

To produce said condensate, monohydric phenol may be condensed with a formaldehyde group compound to produce a homoprecondensate, or a mixture of monohydric phenol and polyhydric phenol may be condensed with a formaldehyde group compound to produce a coprecondensate of monohydric phenol and polyhydric phenol. To produce said coprecondensate, either of said monohydric phenol or polyhydric phenol may be previously condensed with said formaldehyde group compound to produce a precondensate, or both monohydric phenol and polyhydric phenol may be condensed together.

In the present invention, the desirable phenolic resin is phenol-alkylresorcin cocondensation polymer. Said phenol-alkylresorcin cocondensation polymer provides a water solution of said cocondensation polymer (pre-cocondensation polymer) having good stability, and being advantageous in that it can be stored for a longer time at room temperature, compared with a condensate consisting of only a phenol (precondensation polymer). Further, in a case where said sheet material is impregnated or coated with said water solution by precuring, said material has good stability and does not lose its moldability after longtime storage. Further, since alkylresorcin is highly reactive to a formaldehyde group compound, and catches free aldehyde to react with it, the content of free aldehyde in the resin can be reduced.

The desirable method for producing said phenol-alkylresorcin cocondensation polymer is first to create a reaction between phenol and a formaldehyde group compound to produce a phenolic precondensation polymer, and then to add alkylresorcin, and if desired, a formaldehyde group compound, to said phenolic precondensation polymer to create a reaction.

In the case of method (a), for the condensation of monohydric phenol and/or polyhydric phenol and a formaldehyde group compound, said formaldehyde group compound (0.2 to 3 moles) is added to said monohydric phenol (1 mole), after which said formaldehyde group compound (0.1 to 0.8 mole) is added to the polyhydric phenol (1 mole) as usual. If necessary, additives may be added to the phenol resins (the precondensation polymers). In said method(s), there is a condensation reaction caused by applying heat at 55° C. to 100° C. for 8 to 20 hours. The addition of said formaldehyde group compound may be made at once at the beginning of the reaction, or several separate times throughout the reaction, or said formaldehyde group compound may be dropped in continuously throughout said reaction.

Further, if desired, the phenol resins and/or precondensation polymers thereof may be copolycondensed with amino resin monomers such as urea, thiourea, melamine, thiomelamine, dicyandiamine, guanidine, guanamine, acetoguanamine, benzoguanamine, 2,6-diamino-1,3-diamine, and/or with the precondensation polymers of said amino resin monomers.

To produce said phenolic resin, a catalyst or a pH control agent may be mixed in, if needed, before, during or after reaction. Said catalyst or pH control agent is, for example, an organic or inorganic acid such as hydrochloric acid, sulfuric acid, orthophosphoric acid, boric acid, oxalic acid, formic acid, acetic acid, butyric acid, benzenesulfonic acid, phenolsulfonic acid, p-toluenesulfonic acid, naphthalene-α-sulfonic acid, naphthalene-β-sulfonic acid, or the like; an organic acid ester such as oxalic dimethyl ester, or the like; an acid anhydride such as maleic anhydride, phthalic anhydride, or the like; an ammonium salt such as ammonium chloride, ammonium sulfate, ammonium nitrate, ammonium oxalate, ammonium acetate, ammonium phosphate, ammonium thiocyanate, ammonium imide sulfonate, or the like; an organic halide such as monochloroacetic acid or its sodium salt, α, α′-dichlorohydrin, or the like; a hydrochloride of amines such as triethanolamine hydrochloride, aniline hydrochloride, or the like; a urea adduct such as salicylic acid urea adduct, stearic acid urea adduct, heptanoic acid urea adduct, or the like; an acid substance such as N-trimethyl taurine, zinc chloride, ferric chloride, or the like; ammonia, amines, an hydroxide of an alkaline metal or alkaline earth metal such as sodium hydroxide, potassium hydroxide, barium hydroxide, calcium hydroxide, or the like; an oxide of an alkalineearth metal such as lime, or the like; an alkaline substance such as an alkaline metal salt of weak acid such as sodium carbonate, sodium sulfite, sodium acetate, sodium phosphate or the like.

Further, curing agents such as a formaldehyde group compound or an alkylol triazone derivative, or the like, may be added to said phenolic precondensation polymer (including precocondensation polymer).

Said alkylol triazone derivative is produced by the reaction between the urea group compound, amine group compound, and formaldehyde group compound. Said urea group compound used in the production of said alkylol triazone derivative may be such as urea, thiourea, an alkylurea such as methylurea or the like; an alkylthiourea such as methylthiourea or the like; phenylurea, naphthylurea, halogenated phenylurea, nitrated alkylurea, or the like, or a mixture of two or more kinds of said urea group compounds. A particularly, desirable urea group compound may be urea or thiourea. As amine group compounds, an aliphatic amine such as methyl amine, ethylamine, propylamine, isopropylamine, butylamine, amylamine or the like, benzylamine, furfuryl amine, ethanol amine, ethylmediamine, hexamethylene diamine hexamethylene tetramine, or the like, as well as ammonia are illustrated, and said amine group compound is used singly or two or more amine group compounds may be used together.

The formaldehyde group compound(s) used for the production of said alkylol triazone derivative is (are) the same as the formaldehyde group compound used for the production of said phenolic resin precondensation polymer.

To synthesize said alkylol triazone derivatives, commonly 0.1 to 1.2 moles of said amine group compound(s) and/or ammonia, and 1.5 to 4.0 moles of said formaldehyde group compound are reacted with 1 mole of said urea group compound.

In said reaction, the order in which said compounds are added is arbitrary, but preferably, the required amount of formaldehyde group compound is first put in a reactor, after which the required amount of amine group compound(s) and/or ammonia is (are) gradually added to said formaldehyde group compound, the temperature being kept at below 60° C., after which the required amount of said urea group compound(s) is (are) added to the resulting mixture at 80 to 90° C., for 2 to 3 hours, being agitated so as to react together. Usually, 37% by mass of formalin is used as said formaldehyde group compound, but some of said formalin may be replaced with paraformaldehyde to increase the concentration of the reaction product.

Further, in a case where hexamethylene tetramine is used, the solid content of the reaction product obtained is much higher. The reaction between said urea group compound, said amine group compound and/or ammonia, and said formaldehyde group compound is commonly performed in a water solution, but said water may be partially or wholly replaced by one or more kinds of alcohol such as methanol, ethanol, isopropanol, n-butanol, ethylene glycol, diethylene glycol, or the like, and one or more kinds of other water soluble solvent such as ketone group solvent like acetone, methylethyl ketone, or the like can also be used as solvents.

The amount of said curing agent to be added is, in the case of a formaldehyde group compound, in the range of between 10 and 100 parts by mass to 100 parts by mass of said phenolic resin precondensation polymer (precocondensation polymer), and in the case of alkylol triazone, 10 to 500 parts by mass to 100 parts by mass of said phenolic resin precondensation polymer (precocondensation polymer).

[Sulfomethylation and/or Sulfimethylation of Phenol Group Resin]

To improve the stability of said water soluble phenol group resin, said phenol group resin is preferably sulfomethylated and/or sulfimethylated.

### [Sulfomethylation Agent]

The sulfomethylation agents used to improve the stability of the aqueous solution of phenol resins, include such as water soluble sulfites prepared by the reaction between sulfurous acid, bisulfurous acid, or metabisulfurous acid, and alkaline metals, trimethyl amine, quaternary amine or quaternary ammonium (e.g. benzyltrimethylammonium); and aldehyde additions prepared by the reaction between said water soluble sulfites and aldehydes. The aldehyde additions are prepared by the addition reaction between aldehydes and water soluble sulfites as mentioned above, wherein the aldehydes include formaldehyde, acetoaldehyde, propionaldehyde, chloral, furfural, glyoxal, n-butylaldehyde, caproaldehyde, allylaldehyde, benzaldehyde, crotonaldehyde, acrolein, phenyl acetoaldehyde, o-tolualdehyde, salicylaldehyde, or the like. For example, hydroxymethane sulfonate, which is one of the aldehyde additions, is prepared by the addition reaction between formaldehyde and sulfite.

### [Sulfimethylation Agent]

The sulfimethylation agents used to improve the stability of the aqueous solution of phenol resins, include alkaline metal sulfoxylates of an aliphatic or aromatic aldehyde such as sodium formaldehyde sulfoxylate (a.k.a. Rongalite), sodium benzaldehyde sulfoxylate, and the like; hydrosulfites (a.k.a. dithionites) of alkaline metal or alkaline earth metal such as sodium hydrosulfite, magnesium hydrosulfite or the like; and a hydroxyalkanesulfinate such as hydroxymethanesulfinate or the like.

In a case where said phenol group resin precondensate is sulfomethylated and/or sulfimethylated, said sulfomethylation agent and/or sulfimethylation agent is(are) added to said precondensate at any stage to sulfomethylate and/or sulfimethylate said phenol group compound and/or said precondensate.

The addition of said sulfomethylation agent and/or sulfimethylation agent may be carried out at any stage, before, during or after the condensation reaction.

The total amount of said sulfomethylation agent and/or sulfimethylation agent to be added is in the range of between 0.001 and 1.5 moles per 1 mole of said phenol group compound. In a case where the total amount of said sulfomethylation agent and/or sulfimethylation agent to be added is less than 0.001 mole per 1 mole of said phenol group compound, the resulting phenol group resin has an insufficient hydrophilic property, while in a case where the total amount of said sulfomethylation agent and/or sulfimethylation agent to be added is beyond 1.5 mols per 1 mole of said phenol group compound, the resulting phenol group resin has insufficient water resistance.

To maintain good performance, such as the curing capability of said produced precondensate, and the properties of the resin after curing, and the like, the total amount of said sulfomethylation agent and/or sulfimethylation agent is preferably set to be in the range of between about 0.01 and 0.8 mole for said phenol group compound.

Said sulfomethylation agent and/or sulfimethylation agent added to said precondensate, to the sulfomethylation and/or sulfimethylation of said precondensate, react(s) with the methylol group of said precondensate, and/or the aromatic group of said precondensate, introducing a sulfomethyl group and/or sulfimethyl group to said precondensate.

As described above, an aqueous solution of sulfomethylated and/or sulfimethylated phenol group resin precondensate is stable in a wide range, between acidity (pH1.0), and alkalinity, said precondensate being curable in any range, acidity, neutrality, or alkalinity.

In particular, in a case where said precondensate is cured in an acidic range, the remaining amount of said methylol group decreases, solving the problem of formaldehyde being produced by the decomposition of said cured precondensate.

Said synthetic resin binder used in the present invention is provided in liquid type, solution type, emulsion type, and further, many kinds of additives may be added to or mixed into said synthetic resin binder. Said additives may be such as an inorganic filler, such as calcium carbonate, magnesium carbonate, barium sulfate, calcium sulfate, calcium sulfite, calcium phosphate, calcium hydroxide, magnesium hydroxide, aluminium hydroxide, magnesium oxide, titanium oxide, iron oxide, zinc oxide, alumina, silica, diatomaceous earth, dolomite, gypsum, talc, clay, asbestos, mica, calcium silicate, bentonite, white carbon, carbon black, iron powder, aluminum powder, glass powder, stone powder, blast furnace slag, fly ash, cement, zirconia powder, or the like; a natural rubber or its derivative; a synthetic rubber such as styrene-butadiene rubber, acrylonitrile-butadiene rubber, chloroprene rubber, ethylene-propylene rubber, isoprene rubber, isoprene-isobutylene rubber, or the like; a water-soluble macromolecule and natural gum such as polyvinyl alcohol, sodium alginate, starch, starch derivative, glue, gelatin, powdered blood, methyl cellulose, carboxy methyl cellulose, hydroxy ethyl cellulose, polyacrylate, polyacrylamide, or the like; an organic filler such as, wood flour, walnut powder, coconut shell flour, wheat flour, rice flour, or the like; a higher fatty acid such as stearic acid, palmitic acid, or the like; a fatty alcohol such as palmityl alcohol, stearyl alcohol, or the like; a fatty acid ester such as butyryl stearate, glycerin mono stearate, or the like; a fatty acid amide natural wax or composition wax such as carnauba wax, or the like; a mold release agent such as paraffin, paraffin oil, silicone oil, silicone resin, fluorocarbon polymers, polyvinyl alcohol, grease, or the like; an organic blowing agent such as azodicarbonamido, dinitroso pentamethylene tetramine, p,p′-oxibis(benzene sulfonylhydrazide), azobis-2,2′-(2-methylpropionitrile), or the like; an inorganic blowing agent such as sodium bicarbonate, potassium bicarbonate, ammonium bicarbonate or the like; hollow particles such as shirasu balloon, perlite, glass balloon, plastic foaming glass, hollow ceramics, or the like; foaming bodies or particles such as foaming polyethylene, foaming polystyrene, foaming polypropylene, or the like; a pigment; dye; antioxidant; antistatic agent; crystallizer; flame retardant containing phosphorus, flame retardant containing nitrogen, flame retardant containing sulfur, flame retardant containing boron, flame retardant containing bromine, guanidine group flame retardant, phosphate group flame retardant, phosphoric ester flame retardant, amine resin group flame retardant or the like; flameproof agent; water-repellent agent; oil-repellent agent; insecticide agent; preservative; wax; surfactant; lubricant; antioxidant; ultraviolet absorber; plasticizer such as phthalic ester (ex. dibutyl phthalate (DBP), dioctyl phthalate (DOP), dicyclohexyl phthalate) and others (ex. tricresyl phosphate).

To impregnate said synthetic resin binder into said fiber sheet, said fiber sheet is usually dipped into a synthetic resin binder such as liquid synthetic resin, synthetic resin solution, or synthetic resin emulsion; or said liquid synthetic resin or said synthetic resin emulsion is sprayed, or coated using a knife coater, roll coater, flow coater, or the like.

To adjust the synthetic resin content of the binder in said fiber sheet into which said synthetic resin has been impregnated or mixed, said sheet may be squeezed using a squeezing roll or press machine after said synthetic resin has been impregnated or mixed into said fiber sheet. As a result of said squeezing process, the thickness of said fiber sheet may be reduced, and in particular, in a case where said low melting point fibers are contained in said fiber sheet, it is desirable to heat said fiber sheet and melt said low melting point fibers before synthetic resin is impregnated therein, so as to bind the fibers with said melted fibers. Thus, the rigidity and strength of said fiber sheet is improved, so that the workability of said fiber sheet during the process of impregnation with said synthetic resin may be improved, resulting in a remarkable restoration of the thickness of said fiber sheet after having been squeezed.

In a case where said synthetic resin is a phenol group resin, and commonly in the case that it is a novolak type phenol group resin, said phenol group resin is mixed in to said fibers as a powdery precondensate, after which said fibers in to which said powdery precondensate has been mixed are sheeted, and in the case of a precondensate aqueous solution, said precondensate solution is impregnated into or coated on to said fiber sheet.

Commonly, said precondensation polymer is prepared as a water solution, but if desired, a water-soluble organic solvent can also be used in the present invention. Said water-soluble organic solvent may be an alcohol, such as methanol, ethanol, isopropanol, n-propanol, n-butanol, isobutanol, sec-butanol, t-butanol, n-amyl alcohol, isoamyl alcohol, n-hexanol, methylamyl alcohol, 2-ethyl butanol, n-heptanol, n-octanol, trimethylnonylalcohol, cyclohexanol, benzyl alcohol, furfuryl alcohol, tetrahydro furfuryl alcohol, abiethyl alcohol, diacetone alcohol, or the like; a ketone such as acetone, methyl acetone, methyl ethyl ketone, methyl n-propyl ketone, methyl n-butyl ketone, methyl isobutyl ketone, diethyl ketone, di-n-propyl ketone, diisobutyl ketone, acetonyl acetone, methyl oxido, cyclohexanone, methyl cyclohexanone, acetophenon, camphor, or the like; a glycol such as ethylene glycol, diethylene glycol, triethylene glycol, propylene glycol, trimethylene glycol, polyethylene glycol, or the like; a glycol ether such as ethylene glycol mono-methyl ether, ethylene glycol mono-ethyl ether, ethylene glycol isopropyl ether, diethylene glycol mono-methyl ether, triethylene glycol mono-methyl ether, or the like; an ester of the above mentioned glycols such as ethylene glycol diacetate, diethylene glycol mono-ethyl ether acetate, or the like, and their derivatives; an ether such as 1,4-dioxane, and the like; a diethyl cellosolve, diethyl carbitol, ethyl lactate, isopropyl lactate, diglycol diacetate, dimethyl formamide, or the like.

After said synthetic resin binder is impregnated or mixed into said fiber sheet, the resulting fiber sheet is dried. In a case where the synthetic resin in said synthetic resin binder which is impregnated into said fiber sheet is a thermosetting resin, if said thermosetting resin is put in its B stage, the resulting fiber sheet can be stored for a long time, and moreover can be molded in a short time at a low temperature.

### [Flame Retardancy Processing]

For the flame retardancy processing of said fiber sheet of the present invention, polyammonium phosphate, and/or expandable graphite is(are) used as a flame retardant.

Said polyammonium phosphate used in the present invention is difficult to dissolve or insoluble in water. Said polyammonium phosphate being difficult to dissolve or insoluble in water has preferably a polymerization degree between 10 and 40. Herein said degree of polymerization is calculated using the following formula.

$$n = \frac{2 \times {P}_{mol}}{{N}_{mol} \text{-} {P}_{mol}} \qquad [ Formula 1 ]$$

Wherein Pₘₒₗ shows the mole number of phosphorus contained in said polyammonium phosphate, Nₘₒₗ shows the mole number of nitrogen, and Pₘₒₗ and Nₘₒₗ are calculated respectively using the following formulae.

$$\begin{matrix}{P}_{mol} = \frac{P content ( \% by mass ) / 100}{Atomic weight of P ( 30.97 )} & [ Formula 2 ] \\ {N}_{mol} = \frac{N content ( \% by mass ) / 100}{Atomic weight of N ( 14.01 )} & [ Formula 3 ]\end{matrix}$$

The analysis of the P content is carried out using, for example, an IPC emission spectrochemical analysis, with an analysis of the N content being carried out using, for example, a CHN measurement method.

In a case where the polyammonium phosphate has a degree of polymerization greater than 10, said polyammonium phosphate is almost insoluble in water, while in a case where said polyammonium phosphate has a degree of polymerization beyond 40, when said polyammonium phosphate is dispersed in water or an aqueous solvent, the viscosity of the resulting dispersion increases remarkably, so that in a case where said dispersion is coated onto or impregnated into said fiber sheet, said dispersion is difficult to be coated uniformly onto or impregnated into said fiber sheet, and as a result, it is not guaranteed to provide a fiber sheet having excellent flame retardancy.

The expandable graphite used in the present invention is produced by soaking a natural graphite in an inorganic acid such as concentrated sulfuric acid, nitric acid, selenic acid or the like, and then treating it with an oxidizing agent such as perchloric acid, perchlorate, permanguate, bichromate, hydrogen peroxide or the like, said expandable graphite having an expansion start temperature in the range of between about 250 and 300° C. The expansion volume of said expandable graphite is in the range of between about 30 and 300 ml/g, its particle size being in the range of between about 300 and 30 mesh.

Said polyammonium phosphate; expandable graphite, or thermally expandable particles is(are) commonly mixed in with said fiber mixture before a sheet or mat is formed using said fibers, or in a case where the synthetic resin binder is impregnated into or coated onto said sheet or mat, or in a case where the synthetic resin binder is mixed into said fibers, said polyammonium phosphate, expandable graphite, or thermally expandable particles may be mixed into said synthetic resin binder. Any mixing ratio can be applied, but commonly 0.5 to 100% by mass of said polyammonium phosphate, or in a case of said expandable graphite, 0.5 to 50% by mass of said expandable graphite, or in a case of said thermally expandable particles, 0.1˜50% by mass of said thermally expandable particles, is (are) mixed in with said fiber mixture.

In a case where said synthetic resin binder is a water solution, a water soluble resin is preferably dissolved in said water solution. Said water soluble resin may include such as polysodium acrylate, partial saponified polyacrylate, polyvinylalcohol, carboxy methyl cellulose, methyl cellulose, ethyl cellulose, hydroxyl ethyl cellulose, or the like. Further, an alkali soluble resin such as a copolymer of acrylic acid ester and/or methacrylic acid ester, and an acrylic acid and/or methacrylic acid, or a slightly cross-linked copolymer of the above mentioned copolymer, and the like may be used as said water soluble resin of the present invention. Said copolymer or said slightly cross-linked copolymer is commonly provided as an emulsion.

In a case where said water soluble resin is dissolved in said synthetic resin water solution, said water solution may be thickened to improve the stability of its dispersion, making it difficult for said polyammonium phosphate and said expandable graphite sediment, preparing a uniform dispersion.

Further, the adhesiveness of said polyammonium phosphate and said expandable graphite to said fibers may be improved by said water soluble resin, preventing the release of said polyammonium phosphate and said expandable graphite from said fiber sheet.

Said water soluble resin may commonly be added to said water solution in an amount in the range of between 0.1 and 20% by mass as a solid.

Further, to add said polyammonium phosphate, and/or expandable graphite to said fiber sheet, said polyammonium phosphate, and/or expandable graphite is(are) dispersed in a said synthetic resin binder; or synthetic resin aqueous solution of water soluble resin such as polysodium acrylate, partially saponified polyacrylate, polyvinylalcohol, carboxy methiy cellulose, methyl cellulose, hydroxymethyl cellulose, hydroxyl ethyl cellulose or the like: or a synthetic resin emulsion such as an emulsion of alkali soluble resin such as a copolymer of acrylate and/or methacrylate, and acrylic acid and/or methacrylic acid, or a slightly cross linked copolymer as described above, or the like, to prepare a dispersion, and the resulting dispersion may be coated onto or impregnated into said fiber sheet.

To disperse said polyammonium phosphate, expandable graphite, into said synthetic resin emulsion or aqueous solution, a homomixer, a supersonic wave type emulsifying machine or the like is preferably used.

In a case where a supersonic type emulsifying machine is used, said polyammonium, or expandable graphite, is uniformly dispersed in said aqueous solution or synthetic resin emulsion. In particular, said expandable graphite is powdered by the supersonic effect, and in a case where said synthetic resin emulsion or aqueous solution into which said powdered expandable graphite has been uniformly dispersed is impregnated in to a fiber sheet, said expandable graphite easily penetrate to the inside of said fiber sheet, improving the flame retardancy of said fiber sheet.

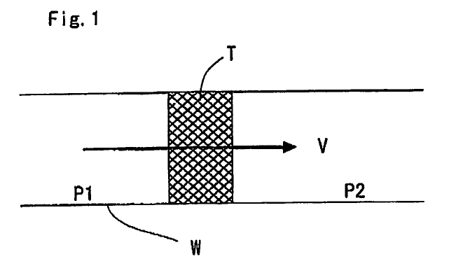

The ventilation resistance of said fiber sheet of the present invention is set to be in the range of between 0.08 and 13.00 kPa·s/m. Herein the ventilation degree resistance R (Pa·s/m) is a measure of the degree of ventilation of air permeable material. Said ventilation resistance R is measured by the stationary flow differential pressure measurement method. As shown in FIG. 1, a test piece T is set in the cylindrical ventilation passage W, and the differential pressure between the pressure P1 in said ventilation passage at the start point side of the arrow in FIG. 1 and the pressure P2 in said ventilation passage at the end point side of the arrow in FIG. 1, is measured, the ventilation resistance R being calculated by the following formula.

R=ΔP/V (formula)

Wherein ΔP(=P1−P2): differential pressure, V: ventilation volume for unit area (m³/m²·S).

Herein the ventilation resistance R(Pa·s/m) and ventilation degree C (m/Pa·s) have following relation respectively.

C=1/R

The ventilation resistance R is measured with such as the ventilation tester (Name: KES-F8-AP1, Kato Tec Co., Ltd, the stationary flow differential pressure measurement method).

A sound absorbing fiber sheet consisting of a fiber sheet having a ventilation resistance in the range of between 0.08 and 3.00 kPa·s/m has an excellent sound absorbing property.

Further, the unit weight of said fiber sheet of the present invention is ordinarily set to be in the range of between 15 and 200 g/m².

### [Fiber Base Sheet]

As a fiber base sheet on one or both sides of which said sound absorbing fiber sheet(s) of the present invention is(are) laminated, a fiber sheet made of the same material and manufactured in the same method as said sound absorbing fiber sheet may be used, provided that the unit weight of said fiber base sheet is ordinarily set to be in the range of between 100 and 2000 g/m2. Since said sound absorbing fiber sheet of the present invention has an excellent sound absorbing property, said fiber base sheet having a light unit weight can be used adequately.

### [Laminated Fiber Sheet]

In the bonding between said sound absorbing fiber sheet of the present invention and said fiber base sheet, a hot melt sheet or a hot melt adhesive powder may be used, or in a case where a synthetic resin binder is coated onto or impregnated into the fiber sheet of said sound absorbing fiber sheet or said fiber base sheet, said synthetic resin binder may be used as an adhesive.

Said hot melt sheet or said hot melt adhesive powder consists of a synthetic resin having a low melting point such as a polyolefin group resin (including a modified polyolefin group resin) such as polyethylene, polypropylene, ethylene-vinylacetate copolymer, ethylene-ethyl acrylate copolymer; polyurethane, polyester, polyester copolymer, polyamide, polyamide copolymer, and two or more kinds of said synthetic resin having a low melting point may be used together.

In a case where said hot melt sheet is used for bonding, for instance, a hot melt sheet extruded from a T-die is laminated onto said fiber sheet of the present invention, and further, said fiber sheet is laminated onto said fiber base sheet to make said laminated fiber sheet.

For the purpose of ensuring air permeability, said hot melt sheet is preferably porous. To make said hot-melt sheet porous, a lot of fine holes are first made on said hot-melt sheet, or said hot-melt sheet is laminated on to said flame retardant sheet, and then needle punched, or the like, or a heated and softened hot-melt sheet which has been extruded from the T die is laminated on to said fiber sheet, after which the layered material is pressed. The resulting film may become porous, having a lot of fine holes. Said holes in said thermoplastic resin film may be formed by the shag on the surface of said fiber sheet. In this method, no process is necessary to form holes in said film, and fine holes may give the product an improved sound absorption property. In a case where said hot-melt adhesive powder is used for adhesion, the resulting molded article's air permeability is ensured.

The ventilation resistance of said molded laminated sheet manufactured by the molding of said laminated sheet is preferably in the range of between 0.1 and 100 kPa·s/m. Said molded laminated sheet has an excellent sound absorption property.

### [Molding of the Laminated Fiber Sheet]

Said laminated fiber sheet of the present invention may be molded into a flat panel shape or a prescribed shape and ordinarily a hot pressing may be applied for the molding. In a case where a thermosetting synthetic resin binder is impregnated into said fiber sheet and/or said fiber base sheet, said hot pressing is carried out at a temperature higher than the curing temperature of sad thermosetting synthetic resin, and in a case where fiber having a low melting point is mixed into said fiber sheet and/or said fiber base sheet, or where a thermoplastic synthetic resin binder is impregnated into said fiber sheet and/or said fiber base sheet, said hot pressing is carried out at a temperature higher than that of the melting point of said low melting point fiber or the softening point of said thermoplastic synthetic resin.

In a case where expandable graphite is adhered to said fiber sheet, being a sound absorbing fiber sheet and/or said fiber base sheet in said laminated fiber sheet, said hot pressing is carried out at a temperature below its expansion start temperature, and in a case where a thermally expandable particles are mixed into said fiber sheet and/or said fiber base sheet, said laminated fiber sheet is hot-molded restricting the thickness of said laminated fiber sheet for the expansion of said thermally expandable particles. When said laminated fiber sheets are heated at a temperature higher than the expansion temperature of said thermally expandable particles contained in said laminated fiber sheet, restricting the thickness of said laminated fiber sheet, said thermally expandable particles expand. Since the thickness of said laminated fiber sheet is restricted during the hot pressing as described above, the fibers around said thermally expandable particles may be compressed, the result being a high density of fibers, which improve the rigidity of said laminated fiber sheet. Nevertheless, the air space ratio of said fiber sheet or said fiber base sheet does not change as a whole, so that the weight of said laminated fiber sheet also remains unchanged. Said laminated fiber sheet of the present invention may be hot pressed into a prescribed sheet after said laminated sheet is molded into a flat panel shape, and in a case where fiber having a low melting point or a thermoplastic synthetic resin binder is contained in said laminated fiber sheet, said laminated fiber sheet may be cold pressed into a prescribed shape after being heated to soften said low melting point fiber or said thermoplastic synthetic resin. A plural number of said fiber sheet or said fiber base sheet may be lapped into said laminated fiber sheet. Said fiber sheet of the present invention is useful as a base panel for the interior or exterior of a car, such as head lining, dash silencer, hood silencer, under engine cover silencer, cylinder head cover silencer, outer dash silencer, floor mat, dash board, door trim, or reinforcement that is laminated on to said base panel, or a sound insulating material, heat insulating material, or building material.

To manufacture said molded laminated fiber sheet of the present invention, many methods can be applied for instance a method wherein said fiber base sheet is first molded, following which said fiber sheet, being a sound absorbing fiber sheet, is then laminated onto said molded fiber base sheet.

EXAMPLES of the present invention are described below. However, the scope of the present invention should not be limited by only said EXAMPLES.

### Example 1

Forty parts by mass of a phenol-form aldehyde precondensation polymer (water solution: solid content 60% by mass), and 60 parts by mass of water were mixed together to prepare a resin water solution, and a spun bonded nonwoven fabric made of a long polyester fiber (unit weight 30 g/m²) was dipped into said resin water solution to impregnate said resin water solution into said nonwoven fabric in an amount of 30% by mass as a solid, following which a dispersion mixture consisting of 40 parts by mass of an acrylic resin emulsion (solid content 50% by mass), 20 parts by mass of a polyammonium phosphate (average degree of polymerization n=30, particle size: 50 to 75 μm) and 40 parts by mass of a polyvinyl alcohol (water solution: solid content 5 parts by mass) was prepared, following which said dispersion mixture was spray coated onto the back side of said nonwoven fabric with a coating amount of 20 g/m² as a solid. After coating, said nonwoven fabric was then dried and pre-cured at 120° C. for 10 minutes in a dryer to prepare a fiber sheet (1). The ventilation resistance of said fiber sheet (1) was 0.08 kPa·s/m.

### Example 2

A fiber sheet (2) was prepared in the same manner as in EXAMPLE 1, with the exception that the coating amount of said dispersion mixture was set to be 60 g/m². The ventilation resistance of said fiber sheet was 0.91 kPa·s/m.

### Comparison 1

A fiber sheet C1 was manufactured in the same manner as in EXAMPLE 1, with the exception that the spray coating of said dispersion mixture consisting of acrylic resin emulsion, polyammonium phosphate and polyvinyl alcohol was omitted.

The ventilation resistance of said fiber sheet (C1) was 0.02 kPa·s/m.

### Comparison 2

A fiber sheet C2 was manufactured in the same manner as in EXAMPLE 1 with the exception that the coating amount of said dispersion mixture was set to be 5 g/m².

The ventilation resistance of said fiber sheet (C2) was 0.05 kPa·s/m.

### Comparison 3

A fiber sheet C3 was manufactured in the same manner as in EXAMPLE 1 with the exception that the coating amount of said dispersion mixture was set to be 200 g/m². The ventilation resistance of said fiber sheet (C3) was 3.5 kPa·s/m.

### Example 3

A resin mixture solution consisting of 40 parts by mass of a sulfomethylated phenol-alkylresorcin-formaldehyde precondensation polymer (water solution: solid content 40% by mass), 2 parts by mass of a carbon black dispersion (solid content 30% by mass), 3 parts by mass of a fluorine group water and oil repellant agent (solid content 20% by mass) and 55 parts by mass of water was prepared.

A spun bonded nonwoven fabric made of a long polyester fibers (unit weight 50 g/m²) was dipped into said resin mixture solution in an impregnating amount of 40% by mass as a solid.

A dispersion mixture consisting of 40 parts by mass of an acrylic resin emulsion (solid content 50% by mass), 20 parts by mass of a polyammonium phosphate (average degree of polymerization n=40, particles size: 50 to 75 μm), 5 parts by mass of an expandable graphite (particle size: 70 to 80 μm, expansion starting temperature: 300° C., expansion ratio: 300 ml/m²), and 35 parts by mass of water was prepared and said dispersion mixture was then spray coated onto the back side of said nonwoven fabric in a coating amount of 40 g/m² as a solid, after which said nonwoven fabric was dried and pre-cured at 120° C. for 10 minutes in a dryer to prepare a fiber sheet (3).

The ventilation resistance of said fiber sheet (3) was 1.51 kPa·s/m.

### Comparison 4

A fiber sheet (C4) was prepared in the same manner as in EXAMPLE 3 with the exception that said dispersion mixture was coated in a coating amount of 10 g/m² as a solid. The ventilation resistance of said fiber sheet (C4) was 0.04 kPa·s/m.

### Example 4

A web of a fiber mixture consisting of 80 parts by mass of a polyester fiber and 20 parts by mass of a core-shell type composite polyester fiber having a low melting point (melting point of shell component: 130° C.) was treated by needle punching to prepare a nonwoven fabric, after which the calendar processing treatment was administered onto one side of said nonwoven fabric (unit weight 80 g/m²). A resin mixture solution consisting of 30 parts by mass of a sulfomethyulated phenol-alkyl resorcin-formaldehyde pre-condensation polymer (water solution: solid content 50% by mass), 2 parts by mass of a carbon black dispersion (solid content: 30% by mass), 3 parts by mass of a fluorine group water and oil repellent agent (solid content: 20% by mass) and 65 parts by mass of water was prepared. Said nonwoven fabric was dipped into said resin mixture solution, setting the amount of said resin mixture solution to be impregnated into said nonwoven fabric to be 30% by mass as a solid. A dispersion mixture consisting of 50 parts by mass of an acrylic resin emulsion (solid content: 50% by mass), 5 parts by mass of a phosphoric acid ester group flame retardant, 5 parts by mass of an expandable graphite (particle size: 70 to 80 μm, expansion starting temperature: 300° C., expansion ratio: 300 ml/m²), and 40 parts by mass of water was prepared, following which said dispersion mixture was then spray coated onto the back side of said nonwoven fabric, the coating amount being set to be 80 g/m² as a solid, following which said nonwoven fabric was then procured by heating at 120° C. for 10 minutes in a dryer to obtain a fiber sheet (4). The ventilation resistance of said fiber sheet was 2.01 kPa·s/m.

### Comparison 5

A fiber sheet (C5) was prepared in the same manner as in EXAMPLE 4 with the exception that the coating amount of said dispersion mixture was set to be 15 g/m².

The ventilation resistance of the resulting fiber sheet (C5) was 0.06 kPa·s/m).

### Comparison 6

A fiber sheet (C6) was prepared in the same manner as in EXAMPLE 4 with the exception that the coating amount of said dispersion mixture is set to be 250 g/m². The ventilation resistance of said fiber sheet (C6) was 0.06 kPa·s/m.

### Comparison 7

A fiber sheet (C7) was prepared in the same manner as in EXAMPLE 4 with the exception that spraying said dispersion mixture consisting of acrylic resin emulsion, phosphoric acid ester group flame retardant, expandable graphite and water was omitted. The ventilation resistance of said fiber sheet (C7) was 0.04 kPa·s/m.

### Sound Absorption Test

Glass wool raw source sheets, each having unit weights of 500 g/m², 800 g/m², and 1000 g/m², (glass wool sheets) were used for base fiber sheets, an uncured phenol group resin being coated onto each glass wool sheet (base fiber sheet). Said glass wool sheet (base fiber sheet) single (sample No. 0), laminated fiber sheets prepared by putting fiber sheet (1) of EXAMPLE 1 (Sample No. 1), fiber sheet (2) of EXAMPLE 2 (Sample No. 2), fiber sheet (3) of EXAMPLE 3 (Sample No. 3), fiber sheet (4) of EXAMPLE 4 (Sample No. 4) and fiber sheet (C1) of COMPARISON 1 (Sample No. C1), fiber sheet (C2) of COMPARISON 2 (Sample No. C2), fiber sheet (C3) of COMPARISON 3 (Sample No. C3), fiber sheet (C4) of COMPARISON 4 (Sample No. C4), fiber sheet (C5) of COMPARISON 5 (Sample No. C5), fiber sheet (C6) of COMPARISON 6 (sample No. C6), fiber sheet (C7) of COMPARISON 7 (Sample No. C7) onto each one side of said glass wool sheets as respective base fiber sheets, were then hot pressed at 200° C. for 60 seconds to prepare molded fiber sheets as samples (No. 0, No. 1, No. 2, No. 3, No. 4, No. C1, No. C2, No. C3, No. C4, No. C5, No. C6, No. C7), each molded fiber sheet having a thickness of 10 mm.

The sound absorbing ratio (%) in a case where sound waves were aimed vertically at each sample was determined. The results are shown in Tables 1 to 3, and total weight of each sample containing, glass wool sheet (base fiber sheet), fiber sheet, thermosetting synthetic resin and other resins (molded laminated sheet) are shown in Table 4.

TABLE 1
unit weight of base fiber sheet 500 g/m²

| | Frequency (Hz) | | | | | | | | | | | |
|---|---|---|---|---|---|---|---|---|---|---|---|---|
| | 200 | 500 | 800 | 1000 | 1250 | 1600 | 2000 | 2500 | 3150 | 4000 | 5000 | 6300 |
| No. 0 | 2.0 | 5.1 | 8.4 | 12.1 | 16.4 | 22.0 | 28.0 | 36.3 | 44.1 | 57.1 | 67.5 | 71.1 |
| No. 1 | 2.1 | 6.9 | 12.5 | 18.1 | 26.2 | 37.5 | 51.4 | 64.9 | 77.3 | 88.1 | 93.3 | 94.6 |
| No. 2 | 2.3 | 8.0 | 13.5 | 18.7 | 25.7 | 40.1 | 52.8 | 66.7 | 78.9 | 90.2 | 94.8 | 95.7 |
| No. 3 | 2.3 | 8.0 | 14.0 | 19.6 | 27.2 | 39.1 | 53.4 | 67.2 | 79.4 | 89.1 | 94.9 | 96.0 |
| No. 4 | 2.4 | 7.8 | 14.3 | 20.5 | 29.1 | 41.0 | 56.0 | 70.4 | 83.0 | 93.6 | 96.3 | 96.3 |
| No. C1 | 2.0 | 5.4 | 12.0 | 15.3 | 20.0 | 28.2 | 34.6 | 44.1 | 56.0 | 69.3 | 80.0 | 85.2 |
| No. C2 | 2.0 | 5.2 | 10.3 | 13.0 | 17.5 | 23.8 | 30.2 | 37.6 | 45.2 | 59.2 | 68.3 | 72.4 |
| No. C3 | 3.0 | 8.2 | 20.3 | 25.7 | 65.1 | 72.7 | 80.1 | 79.6 | 62.7 | 50.1 | 32.5 | 30.0 |
| No. C4 | 2.1 | 5.5 | 12.0 | 15.6 | 21.3 | 28.5 | 35.2 | 44.3 | 57.0 | 69.7 | 81.0 | 85.5 |
| No. C5 | 2.0 | 5.3 | 11.1 | 13.2 | 17.7 | 22.9 | 30.3 | 37.8 | 46.1 | 60.0 | 68.9 | 72.7 |
| No. C6 | 3.2 | 10.1 | 22.4 | 30.1 | 69.7 | 88.2 | 80.5 | 75.5 | 60.3 | 49.9 | 30.1 | 30.3 |
| No. C7 | 2.0 | 5.5 | 12.1 | 15.5 | 21.3 | 29.0 | 35.2 | 45.2 | 57.1 | 70.2 | 80.8 | 86.0 |

TABLE 2
unit weight of base fiber sheet 800 g/m²
Frequency (Hz)

| | 200 | 500 | 800 | 1000 | 1250 | 1600 | 2000 | 2500 | 3150 | 4000 | 5000 | 6300 |
|---|---|---|---|---|---|---|---|---|---|---|---|---|
| No. 0 | 2.1 | 5.4 | 10.0 | 15.4 | 22.5 | 31.1 | 41.2 | 54.8 | 67.2 | 81.0 | 89.1 | 93.1 |
| No. 1 | 2.8 | 10.3 | 21.0 | 30.3 | 42.6 | 57.0 | 70.1 | 80.0 | 89.4 | 95.1 | 96.3 | 97.0 |
| No. 2 | 3.0 | 12.7 | 21.7 | 32.7 | 45.1 | 59.5 | 69.8 | 81.4 | 91.6 | 98.0 | 99.2 | 99.0 |
| No. 3 | 3.1 | 12.8 | 24.4 | 33.3 | 47.0 | 62.2 | 71.9 | 83.7 | 93.6 | 96.2 | 97.0 | 96.3 |
| No. 4 | 3.2 | 11.6 | 23.0 | 34.3 | 47.2 | 62.2 | 74.3 | 85.4 | 95.1 | 98.0 | 98.0 | 97.8 |
| No. C1 | 2.2 | 7.1 | 14.1 | 19.0 | 25.5 | 35.3 | 48.0 | 61.4 | 74.2 | 85.3 | 94.4 | 96.3 |
| No. C2 | 2.1 | 7.3 | 12.6 | 15.9 | 22.1 | 32.3 | 44.4 | 57.7 | 69.3 | 81.7 | 91.2 | 94.6 |
| No. C3 | 3.1 | 8.8 | 21.2 | 26.9 | 66.3 | 75.1 | 82.7 | 80.1 | 60.4 | 50.0 | 31.2 | 29.9 |
| No. C4 | 2.0 | 7.3 | 12.7 | 16.0 | 22.2 | 32.3 | 44.2 | 57.9 | 70.0 | 82.0 | 91.3 | 95.5 |
| No. C5 | 2.1 | 7.4 | 12.7 | 16.3 | 22.5 | 33.9 | 45.7 | 58.6 | 70.0 | 82.3 | 91.7 | 94.6 |
| No. C6 | 3.3 | 10.1 | 25.5 | 31.3 | 70.7 | 87.6 | 88.2 | 75.0 | 64.3 | 49.2 | 45.3 | 44.7 |
| No. C7 | 2.0 | 7.2 | 11.4 | 16.3 | 21.2 | 32.6 | 44.4 | 57.5 | 69.6 | 82.2 | 91.1 | 95.0 |

TABLE 3
unit weight of base fiber sheet 1000 g/m²

| | Frequency (Hz) | | | | | | | | | | | |
|---|---|---|---|---|---|---|---|---|---|---|---|---|
| | 200 | 500 | 800 | 1000 | 1250 | 1600 | 2000 | 2500 | 3150 | 4000 | 5000 | 6300 |
| No. 0 | 3.0 | 8.1 | 13.1 | 18.8 | 26.7 | 38.1 | 51.1 | 65.0 | 77.7 | 87.0 | 93.1 | 95.1 |
| No. C7 | 3.0 | 9.4 | 15.6 | 22.0 | 30.4 | 42.5 | 55.6 | 69.9 | 81.5 | 92.6 | 96.5 | 97.0 |

TABLE 4

| | | | Coating amount (g/m²) | | Unit weight of |
|---|---|---|---|---|---|
| | Unit weight (g/m²) | | Thermosetting | | molded laminated |
| | Glass wool | Nonwoven fabric | resin | Other resin | sheet (g/m²) |
| No. 0 | 500 | — | — | — | 500 |
| No. 1 | 500 | 30 | 9 | 20 | 559 |
| No. 2 | 500 | 30 | 9 | 60 | 599 |
| No. 3 | 500 | 50 | 20 | 40 | 610 |
| No. 4 | 500 | 80 | 24 | 80 | 684 |
| No. C1 | 500 | 30 | 9 | — | 539 |
| No. C2 | 500 | 30 | 9 | 5 | 544 |
| No. C3 | 500 | 30 | 9 | 200 | 739 |
| No. C4 | 500 | 50 | 20 | 10 | 580 |
| No. C5 | 500 | 80 | 24 | 15 | 619 |
| No. C6 | 500 | 80 | 24 | 250 | 854 |
| No. C7 | 500 | 80 | 24 | — | 604 |
| No. 0 | 800 | — | — | — | 800 |
| No. 1 | 800 | 30 | 9 | 20 | 859 |
| No. 2 | 800 | 30 | 9 | 60 | 895 |
| No. 3 | 800 | 50 | 20 | 40 | 910 |
| No. 4 | 800 | 80 | 24 | 80 | 984 |
| No. C1 | 800 | 30 | 9 | — | 839 |
| No. C2 | 800 | 30 | 9 | 5 | 844 |
| No. C3 | 800 | 30 | 9 | 200 | 1039 |
| No. C4 | 800 | 50 | 20 | 10 | 880 |
| No. C5 | 800 | 80 | 24 | 15 | 919 |
| No. C6 | 800 | 80 | 24 | 250 | 1154 |
| No. C7 | 800 | 80 | 24 | — | 904 |
| No. 0 | 1000 | — | — | — | 1000 |
| No. C7 | 1000 | 80 | 24 | — | 1104 |

### Test Results]

Referring to the results of the base fiber sheets (glass wool sheet) single into which said thermosetting synthetic resin has been impregnated in Tables 1, 2, and 3, it is clear that the sound absorbing performance of the molded base fiber sheet is affected by the unit weight of said base fiber sheet, and that the sound absorbing performance improves according to the increasing of the unit weight of said base fiber sheet.

Referring to the results of the molded laminated fiber sheets using said fiber sheet (C1) of COMPARISON 1 and molded laminated fiber sheet (C7) of COMPARISONS 7 in Tables 1, 2, and 3, the ventilation resistance of each molded base fiber sheet (glass wool raw sauce sheet) into which thermosetting synthetic resin has been impregnated is in the range of between 0.02 and 0.04 kPa·s/m and, it is recognized that the sound absorbing performances of molded laminated fiber sheets using fiber sheet C1 and fiber sheet C7 are almost similar to the sound absorbing performances of said molded base fiber sheets.

Referring to the results of Samples No. 1 to 4 in Tables 1 and 2, Samples No. 1 to 4 relating to EXAMPLES 1 to 4, and Sample No. 7 in Table 3, Sample No. 7 relating to COMPARISON 7, it is recognized that even in a case where glass wool sheet (base fiber sheet) having a unit weight of 500 g/m² is used in said molded laminated fiber sheet, the resulting molded laminated fiber sheet has a sound absorbing performance which bears comparison with that of Sample No. 0, which is a molded glass wool sheet having a unit weight of 1000 g/m² if the fiber sheet ventilation resistance of which is set to be in the range of between 0.08 and 3.00 kPa·s/m) is laminated onto said glass wool sheet. Further, in a case where glass wool sheet having a unit weight of 800 g/m² is used in said molded laminated sheet, the resulting molded laminated fiber sheet has superior sound absorbing performance than said molded glass wool sheet having a unit weight of 1000 g/m².

Further, Table 4 suggests that said molded laminated fiber sheet of the present invention, being lighter than a molded glass wool sheet having a unit weight of 1000 g/m², has a sound absorbing performance similar to or higher than that of a molded glass wool sheet having a unit weight of 1000 g/m². Referring to the results of Sample No. C1, No. C2, No. C4, No. C5 and No. C7 relating to COMPARISONS 1, 2, 4, 5 and 7 in Tables 1, 2 and 3, it is recognized that fiber sheet having a ventilation resistance below 0.08 kPa·s/m does not significantly improve its sound absorbing performance.

Further, referring to the results of Samples No. C3 and No. C6 relating to COMPARISONS 3 and 6 in Tables 1, 2, and 3, it is recognized that in a case where fiber sheet having a ventilation resistance of beyond 3,000 kPa·s/m is used in molded laminated fiber sheet, the sound absorbing performance of the resulting molded laminated fiber sheet may show improvement in the frequency range of between 1000 and 3000 Hz, but the sound absorbing performance of the resulting molded laminated fiber sheet may deteriorate extremely in a frequency range of beyond 3000 Hz.

Considering the aforementioned, by laminating fiber sheet having a properly adjusted ventilation resistance onto the base fiber sheet, the weight of the base fiber sheet can be reduced, and still maintain the sound absorbing performance of a conventional molded laminated fiber sheet.

### Example 5

A fiber mixture consisting of 70 parts by mass of a kenaf fiber (fineness: 12 to 15 dtex, fiber length: 70 mm), 10 parts by mass of a polyester fiber (fineness: 4.4 dtex, fiber length: 55 mm) and 20 parts by mass of a core-shell type polyester composite fiber having a low melting point (fineness: 6.6 dtex, melting point of shell component: 130° C., fiber length: 50 mm) was prepared by mixing and defibrating using a defibrater to make a fleece having a unit weight of 350 g/m², following which a hot wind of 135° C. was blown onto said fleece for 10 to 30 seconds, so as to melt the shell component of said core-shell type polyester composite fiber, and to prepare a fiber sheet having a thickness of 30 mm.

A resin mixture solution consisting of 30 parts by mass of a sulfomethylated phenol-alkylresorcin-formaldehyde precondensation polymer (water solution: solid content 50% by mass), 10 parts by mass of a polyammonium phosphate (average degree of polymerization n=20) and 60 parts by mass of water was prepared, following which said resin mixture solution was impregnated into said fiber sheet, after which said fiber sheet was roll squeezed to adjust the amount of said resin mixture solution impregnated therein to be 50% by mass for the unit weight of said fiber sheet. The resulting fiber sheet into which said resin mixture was impregnated was then dried and procured at 110° C., to prepare a flame retardant fiber sheet.

Said fiber sheet (1) prepared in EXAMPLE 1 was put on one side of said flame retardant fiber sheet and the resulting laminated fiber sheet was then hot-pressed at 200° C. for 70 seconds into a prescribed shape, to prepare a molded laminated fiber sheet having excellent flame retardancy (V-0 in UL94 standard), light weight, and high rigidity.

### Example 6

A fiber mixture consisting of 30% by mass of a bamboo fiber (fineness: 10 to 12 dtex, fiber length: 70 mm), 40% by mass of a kenaf fiber (fineness: 12 to 15 dtex, fiber length: 70 mm), 15% by mass of a carbon fiber (fineness: 6 dtex, fiber length: 60 mm), and 15% by mass of a core-shell type polyester composite fiber having a low melting point (fineness: 6.6 dtex, melting point of shell component: 130° C., fiber length: 55 mm) was prepared by mixing and defibrating using a difibrater to make a fleece having a unit weight of 400 g/m², following which a hot wind of 135° C. was blown onto said fleece for 10 to 30 seconds, to melt the shell component of said core-shell type polyester composite fiber, and to prepare a fiber sheet having a thickness of 30 mm.

A resin mixture solution consisting of 30 parts by mass of a sulfomethylated phenol-alkyl resorcin-formaldehyde precondensation polymer (water solution: solid content 50% by mass), 10 parts by mass of polyammonium phosphate (average degree of polymerization n=30), 2 parts by mass of a carbon black dispersion (solid content: 30% by mass), 2 parts by mass of a fluorine group water-oil repellent (solid content: 20% by mass) and 56 parts by mass of water was prepared then said resin mixture solution was impregnated into said fiber sheet, after which said fiber sheet was roll squeezed to adjust the amount of said resin mixture solution impregnated therein to be 40% by mass for unit weight of said fiber sheet. The resulting fiber sheet into which said resin mixture was impregnated was then dried and procured at 110° C., to prepare a flame retardant fiber sheet.

Said fiber sheets (3) prepared in EXAMPLE 3 as a surface fiber sheet were each put on both sides of said flame retardant fiber sheet as a base fiber sheet, and the resulting laminated fiber sheet was then hot-pressed at 200° C. for 70 seconds into a prescribed shape to prepare a molded laminated fiber sheet having an excellent sound absorbing performance, light weight, high rigidity, and excellent flame retardancy (V-0, in UL94 standard).

### Example 7

A fiber mixture consisting of 50 parts by mass of a recycled fiber from waste fiber (fineness: 5 to 15 detex, fiber length: 20 to 70 mm), 40 parts by mass of a polyester fiber (fineness: 6.6 dtex fiber length: 65 mm) and 10 parts by mass of a polypropylene fiber was prepared.

A resin mixture consisting of 70 parts by mass of a novolak type phenolic resin powder containing hexamethylenetetramine (particle size 60 to 80 μm) as a hardening agent, 5 parts by mass of an expandable graphite (particle size: 70 to 80 μm expansion starting temperature: 300° C.), and 25 parts by mass of polyammonium phosphate (average degree of polymerization n=30, particle size: 50 to 75 μm) was mixed into said fleece, setting the amount of said resin mixture to be mixed into said fiber mixture to be 30% by mass, after which said fleece was pre-cured in a drying oven to prepare a flame retardant fiber sheet having a thickness of 25 mm, and a unit weight of 500 g/m².

A polyamide powder (melting point 110° C., particle size: 150 to 200 μm) as a hot melt adhesive was coated onto the back side of the fiber sheet (4) prepared in EXAMPLE 4 in a coating amount of 10 g/m² and then said fiber sheet (4) was put onto said flame retardant fiber sheet, being a base material. The resulting laminated fiber sheet was then hot-pressed at 200° C. for 90 seconds into a prescribed shape. The resulting molded laminated fiber sheet had, an excellent sound absorbing performance, light weight, high rigidity, and excellent flame retardancy (V-0 in UL94 standard).

### Comparison 8

In EXAMPLE 5, the fiber sheet (1) was put between said flame retardant fiber sheets, to prepare a molded laminated fiber sheet, in the same manner, the resulting molded laminated fiber sheet had a good flame retardancy, but the sound absorbing performance of said molded laminated fiber sheet was not remarkably improved.

### Example 8

A resin mixture solution consisting of 40 parts by mass of a sulfomethylated phenol-alkylresorcin-formaldehyde precondensation polymer (water solution: a solid content 45% by mass), 1 part by mass of a carbon black dispersion (solid content: 30% by mass), 5 parts by mass of a fluorine group water and oil repellent (solid content: 20% by mass), 10 parts by mass of a polyvinyl alcohol (water solution: solid content 5% by mass), and 44 parts by mass of water was prepared, and a nonwoven fabric made of a polyester fiber having a unit weight of 80 g/m² was treated on both sides by calendar processing, following which said resin mixture solution was then roll coated onto said nonwoven fabric to impregnate said resin mixture solution into said nonwoven fabric, so as to adjust the amount to be impregnated to be 20% by mass as a solid for said nonwoven fabric.

A dispersion mixture consisting of 10 parts by mass of a polyamide water dispersion (melting point: 130° C. particle size: 70 to 80 μm, solid content: 30% by mass) as a hot melt adhesive, 15 parts by mass of a polyammonium phosphate (average degree of polymerization n=20, particle size: 50 to 75 μm), 5 parts by mass of a phosphoric ester group flame retardant (solid content 50% by mass), 1 part by mass of a carbon black dispersion (solid content 30% by mass), and 69 parts by mass of water was prepared, and the resulting dispersion mixture was then spray coated onto the back side of said nonwoven fabric to impregnate said dispersion mixture into said nonwoven fabric in an impregnating amount of 20 g/m² as a solid.

Said nonwoven fabric was then dried at 150° C. for 4 minutes in a dryer to prepare a fiber sheet. The ventilation resistance of said fiber sheet was 1.4 kPa·s/m.

The flame retardant fiber sheet prepared in EXAMPLE 5 was used as a base fiber sheet and said fiber sheet was put onto said base fiber sheet as a sound absorber so that the face of said fiber sheet, onto which said dispersion mixture having been spray coated, attached to said base fiber sheet, following which the resulting laminated sheet was hot-pressed at 200° C. for 60 seconds into a prescribed shape, preparing a molded laminated fiber sheet having an excellent sound absorbing performance and a preferable appearance, the flame retardancy of said molded laminated fiber sheet being V-0 in UL94 standard.

### Example 9

A resin dispersion mixture consisting of 50 parts by mass of a sulfomethylated phenol-alkylresorcin-formaldehyde pre-condensation polymer (water solution: solid content 50% by mass), 2 parts by mass of a carbon black dispersion (solid content: 30% by mass), 3 parts by mass of a fluorine group water and oil repellent (solid content 20% by mass), 15 parts by mass of an acrylic resin emulsion (solid content 5% by mass) and 30 parts by mass of water was prepared, then a spunbonded nonwoven fabric made of a polyester long fiber (unit weight 50 g/m²) was dipped into said resin dispersion mixture adjusting the amount to be impregnated to be 25% by mass as a solid component for said nonwoven fabric.

A dispersion mixture consisting of 5 parts by mass of a polyester resin (melting point: 130° C., particle size: 50 to 60 μm, water dispersion: solid content 40% by mass), 20 parts by mass of a polyammonium phosphate (average degree of polymerization n=20, particle size: 50 to 75 μm), 1 part by mass of a carbon black dispersion (solid content 30% by mass) and 74 parts by mass of water was prepared, and the resulting dispersion mixture was then spray coated as a hot melt adhesive onto the back side of said nonwoven fabric in an amount to be 20 g/m² as a solid, following which said nonwoven fabric was then dried at 140° C. for 3 minutes in a dryer to prepare a fiber sheet. The ventilation resistance of said fiber sheet was 2.5 kPa·s/m.

The resulting fiber sheet's one face, onto which said dispersion mixture having been spray coated, was put onto said flame retardant fiber sheet, said resulting fiber sheet being a sound absorbing fiber sheet, and said flame retardant fiber sheet being a base fiber sheet, following which the resulting laminated fiber sheet was then hot-pressed at 200° C. for 60 seconds into a prescribed shape to prepare a laminated fiber sheet, having an excellent sound absorbing performance, light weight, high rigidity, and excellent flame retardancy (V-0 in UL94 standard).

### POSSIBILITY FOR INDUSTRIAL UTILITY

By using the sound absorbing fiber sheet of the present invention, a molded laminated fiber sheet having high rigidity, and an excellent sound absorbing performance is provided so that said molded laminated fiber sheet is very useful as an interior material for such as cars, buildings, and the like. Accordingly the present invention has possibility for industrial utility.

1. A sound absorbing fiber sheet comprising a fiber sheet containing polyammonium phosphate and/or expandable graphite therein, wherein said fiber sheet has a ventilation resistance in the range of between 0.08 and 3.00 kPa·s/m, and a unit weight of 15 to 200 g/m², said polyammonium phosphate having an average degree of polymerization in the range of between 10 and 40.

2. (canceled)

3. A sound absorbing fiber sheet in accordance with claim 1, wherein fibers having a low melting point of below 180° C. are mixed into said fiber sheet.

4. A sound absorbing fiber sheet in accordance with claim 1, wherein said fiber sheet is a nonwoven fabric in which fibers are bound by a synthetic resin binder or intertwined by needling.

5. A sound absorbing fiber sheet in accordance with claim 4, wherein said synthetic resin binder is a phenol group resin.

6. A sound absorbing fiber sheet in accordance with claim 5, wherein said phenol group resin is sulfomethylated and/or sulfimethylated.

7. A molded fiber sheet comprising a molded laminated fiber sheet wherein said sound absorbing fiber sheet in accordance with claim 1 is laminated onto one or both sides of a fiber base sheet.
